(19) United States
(12) Patent Application Publication
(10) Pub. No.: US 2026/0303427 A1
(43) Pub. Date: Oct. 1, 2026

(54) TCI STATE BASED SRS ENHANCEMENT

(71) Applicant: Nokia Technologies Oy, Espoo (FI)

(72) Inventors: Juha Pekka KARJALAINEN, Sotkamo (FI); Sami-Jukka HAKOLA, Kempele (FI); Timo KOSKELA, Oulu (FI); Youngsoo YUK, Seoul (KR)

(73) Assignee: Nokia Technologies Oy, Espoo (FI)

(21) Appl. No.: 19/475,083

(22) PCT Filed: Feb. 27, 2024
(86) PCT No.: PCT/EP2024/054882

§ 371 Date: Oct. 14, 2025

(30) Foreign Application Priority Data
Apr. 14, 2023 (GB) 2305511.4

(51) Int. Cl. H04L 27/26; H04L 1/00; H04L 5/00

(52) U.S. Cl. CPC H04L 27/261; H04L 1/0061; H04L 5/0044

(57) ABSTRACT

Example embodiments of the present disclosure provide a solution for sounding reference signal (SRS) enhancement based on transmission configuration indicator (TCI) states. In an example method, a terminal device receives a TCI state from a network device. The terminal device determines, based on the TCI state, at least one initialization parameter for UL SRS transmissions. The terminal device further transmits a UL SRS to the network device based on the at least one initialization parameter. In this way, UL SRS interference randomization is enhanced.

### FIELD

Example embodiments of the present disclosure generally relate to the field of communication, and in particular, to a terminal device, a network device, methods, apparatuses, and a computer readable medium for sounding reference signal (SRS) enhancement based on transmission configuration indicator (TCI) states.

### BACKGROUND

In new radio (NR) systems, UEs perform UL SRS transmission under control of gNB for multiple input multiple output (MIMO) enhancements. Based on reception of UL SRS resources, the gNB may measure the uplink radio channel. The NR systems support for different UL SRS usage including antenna-switching, beam management, codebook, and non-codebook.

UL cross-SRS interference may impact channel state information (CSI) quality for UL and DL limiting potential merits of coherent joint transmission (CJT) for physical downlink data shared channel (PDSCH) transmission in multi-transmission reception point (TRP) scenarios. To avoid the impact of persistent UL cross-SRS interference on same resource elements from different UEs, SRS enhancement needs to be further studied.

### SUMMARY

In general, example embodiments of the present disclosure provide solutions for SRS enhancement based on TCI states.

In a first aspect, there is provided a terminal device. The terminal device comprises at least one processor and at least one memory storing instructions that, when executed by the at least one processor, cause the terminal device at least to: receive a transmission configuration indicator (TCI) state from a network device; determine, based on the TCI state, at least one initialization parameter for uplink (UL) sounding reference signal (SRS) transmissions; and transmit a UL SRS to the network device based on the at least one initialization parameter.

In a second aspect, there is provided a network device. The network device comprises: at least one processor; and at least one memory storing instructions that, when executed by the at least one processor, cause the network device at least to: transmit a transmission configuration indicator (TCI) state to a terminal device; determine, based on the TCI state, at least one initialization parameter for uplink (UL) sounding reference signal (SRS) receptions; and receive a UL SRS from the terminal device based on the at least one initialization parameter.

In a third aspect, there is provided a method. The method comprises: receiving a transmission configuration indicator (TCI) state from a network device; determining, based on the TCI state, at least one initialization parameter for uplink (UL) sounding reference signal (SRS) transmissions; and transmitting a UL SRS to the network device based on the at least one initialization parameter.

In a fourth aspect, there is provided a method. The method comprises: transmitting a transmission configuration indicator (TCI) state to a terminal device; determining, based on the TCI state, at least one initialization parameter for uplink (UL) sounding reference signal (SRS) receptions; and receiving a UL SRS from the terminal device based on the at least one initialization parameter.

In a fifth aspect, there is provided an apparatus. The apparatus comprises: means for receiving a transmission configuration indicator (TCI) state from a network device; means for determining, based on the TCI state, at least one initialization parameter for uplink (UL) sounding reference signal (SRS) transmissions; and means for transmitting a UL SRS to the network device based on the at least one initialization parameter.

In a sixth aspect, there is provided an apparatus. The apparatus comprises: means for transmitting a transmission configuration indicator (TCI) state to a terminal device; means for determining, based on the TCI state, at least one initialization parameter for uplink (UL) sounding reference signal (SRS) receptions; and means for receiving a UL SRS from the terminal device based on the at least one initialization parameter.

In a seventh aspect, there is provided a non-transitory computer-readable storage medium comprising program instructions. The program instructions, when executed by an apparatus, cause the apparatus to perform at least the following: receiving a transmission configuration indicator (TCI) state from a network device; determining, based on the TCI state, at least one initialization parameter for uplink (UL) sounding reference signal (SRS) transmissions; and transmitting a UL SRS to the network device based on the at least one initialization parameter.

In an eighth aspect, there is provided a non-transitory computer-readable storage medium comprising program instructions. The program instructions, when executed by an apparatus, cause the apparatus to perform at least the following: transmitting a transmission configuration indicator (TCI) state to a terminal device; determining, based on the TCI state, at least one initialization parameter for uplink (UL) sounding reference signal (SRS) receptions; and receiving a UL SRS from the terminal device based on the at least one initialization parameter.

In a ninth aspect, there is provided a computer program comprising instructions, which, when executed by an apparatus, cause the apparatus at least to: receive a transmission configuration indicator (TCI) state from a network device; determine, based on the TCI state, at least one initialization parameter for uplink (UL) sounding reference signal (SRS) transmissions; and transmit a UL SRS to the network device based on the at least one initialization parameter.

In a tenth aspect, there is provided a computer program comprising instructions, which, when executed by an apparatus, cause the apparatus at least to: transmit a transmission configuration indicator (TCI) state to a terminal device; determine, based on the TCI state, at least one initialization parameter for uplink (UL) sounding reference signal (SRS) receptions; and receive a UL SRS from the terminal device based on the at least one initialization parameter.

In an eleventh aspect, there is provided a terminal device. The terminal device comprises: a receiving circuitry configured to receive a transmission configuration indicator (TCI) state from a network device; a determining circuitry configured to determine, based on the TCI state, at least one initialization parameter for uplink (UL) sounding reference signal (SRS) transmissions; and a transmitting circuitry configured to transmit a UL SRS to the network device based on the at least one initialization parameter.

In a twelfth aspect, there is provided a network device. The network device comprises: a transmitting circuitry configured to transmit a transmission configuration indicator (TCI) state to a terminal device; a determining circuitry configured to determine, based on the TCI state, at least one initialization parameter for uplink (UL) sounding reference signal (SRS) receptions; and a receiving circuitry configured to receive a UL SRS from the terminal device based on the at least one initialization parameter.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates an example of intra-cluster interference scenarios for time division duplex (TDD) based coherent joint transmission (C-JT);

FIG. 1C illustrates an example of inter-cluster interference scenarios for TDD based C-JT;

FIG. 2 illustrates an example of a process flow in accordance with some example embodiments of the present disclosure;

FIG. 3 illustrates a flowchart of an example method implemented at a terminal device in accordance with some embodiments of the present disclosure;

FIG. 4 illustrates another flowchart of an example method implemented at a network device in accordance with some embodiments of the present disclosure;

FIG. 5 illustrates a simplified block diagram of a device that is suitable for implementing some example embodiments of the present disclosure; and

FIG. 6 illustrates a block diagram of an example of a computer-readable medium in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “network”, “communication network” or “data network” refers to a network following any suitable communication standards, such as long term evolution (LTE), LTE-advanced (LTE-A), wideband code division multiple access (WCDMA), high-speed packet access (HSPA), narrow band Internet of things (NB-IoT), wireless fidelity (Wi-Fi) and so on. Furthermore, the communications between a terminal device and a network device/element in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP) or a transmission and reception point (TRP), for example, a node B (NodeB or NB), an evolved NodeB (eNodeB or eNB), a NR NB (also referred to as a gNB), a remote radio unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

As used herein, the term “TRP” refers to a transmit-receive point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Rel-15 specification defines that UL SRS transmission is always done under control of gNB. Based on reception of UL SRS resources, the gNB may measure the uplink radio channel and/or determine downlink radio channel when uplink-downlink channel reciprocity is valid. The specification provide support for different UL SRS usages, i.e. antenna-switching, beam management, codebook, and non-codebook. This UE specific UL SRS measurement can then be used for:
Antenna switching: UE antenna switching capability, xTyR
   The indicated UE antenna switching capability of ‘xTyR’ corresponds to a UE, capable of SRS transmission on ‘x’ antenna ports over total of ‘y’ antennas, where ‘y’ corresponds to all or subset of UE receive antennas.
   For UL channel scheduling and link adaptation purposes
   For estimation of the downlink propagation channel when channel reciprocity exists, i.e. TDD deployments. The gNB can use this information for its downlink transmissions for the UE.
Non-codebook: UE transmits a set of precoded UL SRS resources, where each SRS is precoded using a different set of UE generated weights. Based on UL SRS resource transmission, gNB indicates the UE to which of UL SRS resources are used as precoder weights for PUSCH transmission. Non-codebook based transmission assumes channel reciprocity so the UE is able to generate uplink precoding weights based upon downlink measurements
Codebook: UE transmits set of non-precoded UL SRS resources based on which the gNB indicates UL SRS resource, transmit precoder matrix indicator (TPMI) and rank indicator (RI) to be applied for scheduled PUSCH transmission. Codebook based transmission does not assume channel reciprocity so the UE is not able to generate uplink precoding weights based upon downlink measurements
Beam management: UE transmits UL SRS resources for the usage of beam management. In general, this configuration is used when there is no beam correspondence between uplink and downlink beams.

Rel-15 supports UL SRS transmission up to 4 antenna ports (i.e. 1, 2 and 4). For Rel-15 UE is configured with a specific Zadoff-Chu sequence to transmit as the SRS. The length of this sequence is equal to the number of allocated resource elements (RE) subject to RE-patterns, i.e. comb-2, comb-4 and physical resource blocks (PRB)s.

In Rel-15, different antenna ports of single UE are multiplexed in code domain with cyclic shifts associated with Zadoff-Chu sequence as wells configured RE-pattern (i.e. comb-2 or comb-4). A Cyclic shift in the time domain corresponds to a linear phase shift in the frequency domain. The sequence is mapped directly onto the set of resource elements corresponding to a frequency domain sequence. When different UEs are configured to share same UL SRS comb-pattern, different cyclic-shifts are assumed to be configured for UL SRS transmission to avoid inter-SRS interference at gNB.

Rel-15 defines 30 different groups of sequences which are configurable by the gNB. Depending on the sequence length, there is different number of sequences as follows. When the SRS is configured with length of sequence ≤60, there is one sequence associated with each group. When the SRS is configured with length of sequence ≥60, each group includes two sequences for each group. In other words, for the length of sequence ≥60, the SRS can be configured with 60 different sequences.

The specification defines that each sequence group, u, is initialized as follows. The sequence group u=(f_{gh}(n_{s,f}^{μ}, l′)+n_{ID SR})+n_{ID SRS}) mod 30, where N_{ID SRS} is sequence identity which can have values from 0 to 1023. The parameter l′ is the OFDM symbol number within the SRS resource.
if groupOrSequenceHopping equals ‘neither’, neither group, nor sequence hopping shall be used and

$${f}_{gh} ( {n}_{s , f}^{μ} , {l}^{′} ) = 0$$

$$v = 0$$

if groupOrSequenceHopping equals ‘groupHopping’, group hopping but not sequence hopping shall be used and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30$$

$$v = 0$$

where n_{s,f} is slot number within the radio frame, l′ is the OFDM symbol within the slot, l₀ is the starting position in the time domain (counted with respect to the last OFDM symbol within the slot), N^{slot}_{symbol} is the number of symbols within the slot, the pseudo-random sequence c(i) is defined by clause 5.2.1 and shall be initialized with cᵢₙᵢₜ=N_{ID SRS} at the beginning of each radio frame.
if groupOrSequenceHopping equals ‘sequenceHopping’, sequence hopping but not group hopping shall be used and

$${f}_{gh} ( {n}_{s , f}^{μ} , {l}^{′} ) = 0$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

where

$${M}_{s c , b}^{S R S}$$

is the number or PRBs assigned for SRS,

$${N}_{s c}^{R B}$$

sequence allocation in number of PRBs, the pseudo-random sequence c(i) is defined by clause 5.2.1 and shall be initialized with cᵢₙᵢₜ=N_{ID SRS} at the beginning of each radio frame.

NR Rel-17 specification provides support for single user DL PDSCH scheduling up to 8 layers (i.e. rank 8). However, Rel-15 UL SRS resource configuration with antenna switching can provide only support for UEs equipped with 4 RX antenna ports. In other words, even though a UE is equipped with 8 RX antenna ports, only four out of eight antenna ports can be used for DL CSI acquisition at gNB-side based on UL SRS sounding. Clearly, this leads to suboptimal use of potential merits of DL TX precoding as well as RX processing limiting system performance e.g. in terms of spectral efficiency and interference mitigation.

In Rel-17, depending on reported UE's antenna-switching capability, the UE can be configured with the higher layer parameter usage in SRS-ResourceSet set as ‘antennaSwitching’, the UE may be configured with only one of the following configurations depending on the indicated UE capability supportedSRS-TxPortSwitch (‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘t1r8’ for 1T8R, ‘t2r6’ for 2T6R, ‘t2r8’ for 2T8R, ‘t4r8’ for 4T8R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2-t2r2-t1r4-t2r4’ for 1T=1R/1T2R/2T=2R/1T4R/2T4R, ‘t1r1’ for T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4R), where T and R define the number of transmission antenna ports and reception antenna ports at the UE-side, respectively. The indicated UE antenna switching capability of ‘xTyR’ corresponds to a UE, capable of SRS transmission on ‘x’ antenna ports over total of ‘y’ antennas, where ‘y’ corresponds to all or subset of UE receive antennas.

Rel-17 introduces also new comb-pattern, i.e. comb-8 with 6 as maximum number of cyclic-shifts. Table 1 summarizes the supported comb-pattern values, KTC and maximum number of cyclic-shifts.

TABLE 1
[TS 38.211 Table 6.4.1.4.2-1:] Maximum number of cyclic shift
${n}_{SRS}^{cs , max} as a function of {K}_{TC} .$

| K_{TC} | ${n}_{SRS}^{cs , max}$ |
|---|---|
| 2 | 8 |
| 4 | 12 |
| 8 | 6 |

In Rel-18, it is important to identify and specify necessary enhancements for uplink MIMO, while necessary enhancements on downlink MIMO that facilitate the use of large antenna array, not only for FR1 but also for FR2, would still need to be introduced to fulfil the request for evolution of NR deployments.

One of the objectives of Rel-18 NR MIMO Evo DL UL is to discuss and define how to provide specification support for SRS enhancement to manage inter-Transmission Reception Point (TRP) cross-SRS interference targeting TDD CJT via SRS capacity enhancement and interference randomization as follows:
1. Study, and if justified, specify enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off.
   SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences.
   Note: the maximum number of CSI-RS ports per resource remains the same as in Rel-17, i.e. 32.

Uplink (UL) Sounding Reference Signal (SRS) (i.e. cross-SRS) interference may impact channel state information (CSI) quality for UL and DL limiting potential merits (e.g., interference reduction and throughput enhancements) of TDD based coherent joint transmission (CJT) for physical downlink data shared channel (PDSCH) transmission in multi-TRP scenarios. UL SRS interference or cross-SRS occurs when the different SRS sequences with corresponding SRS resources overlap in resource element (RE) domain (i.e. sharing same symbol, RBs, and same comb offset). To avoid the impact of persistent strong UL cross-SRS interference on same resource elements from different UEs, interference randomization in a form of UL SRS comb-offset hopping and cyclic shift hopping can be seen as attractive approach for Rel-18.

In RAN1 #112 meeting, it was agreed that Rel-18 will provide specification support for both comb-offset and cyclic shift hopping schemes as follows:
Agreement (RAN1 #112 Athens)
For SRS interference randomization, support:
   Opt. 3: Both cyclic shift hopping and comb offset hopping.
      At least the two features can be separately configured
      FFS: Combined cyclic shift hopping and comb offset hopping for a UE
      FFS: Separate or combined with SRS sequence group hopping/sequence hopping
      FFS: Associated UE capability

Furthermore, in RAN1 #112 meeting, two different options to initialize comb-offset and/or cyclic shift hopping have been identified to be further down-selected in next RAN1 #112-bis e-meeting.
Agreement (RAN1 #112 Athens)
For SRS comb offset hopping and/or cyclic shift hopping, for each SRS port, the hopping pattern is determined based on the pseudo-random sequence c(i), initialized with one of the following IDs.
   Option 1: Reuse the SRS sequence identity N_{ID SRS}.
   Option 2: Introduce new ID(s).
      FFS: the value range, one new ID or two separate new IDs, default ID(s)

Embodiments of the present disclosure relate to 3GPP New Radio (NR) physical layer design for multiple input multiple output (MIMO) enhancements in Rel-18 and beyond, in particular, to the SRS enhancement based on TCI states. In some embodiments, group based initialization method is further introduced for UL SRS comb offset and cyclic shift hopping interference randomization

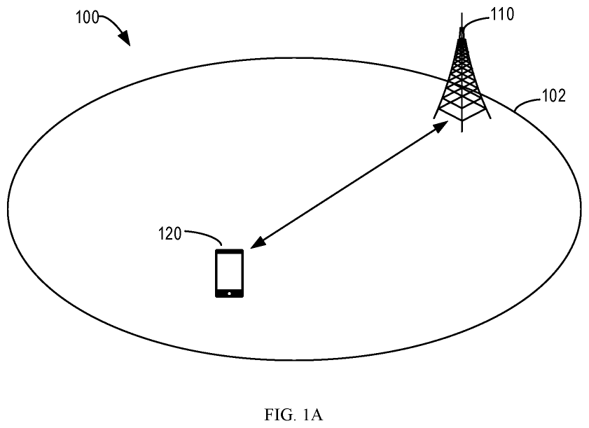

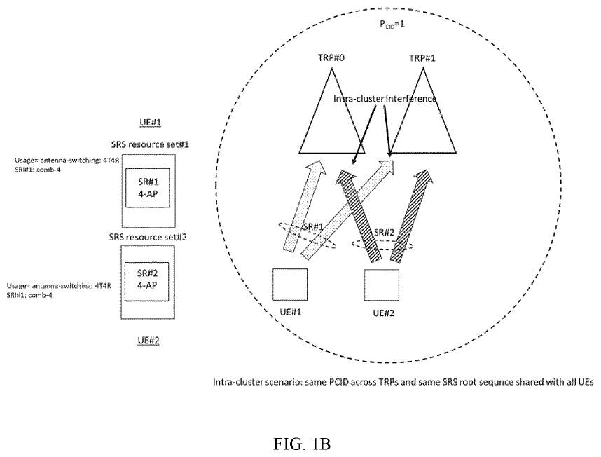

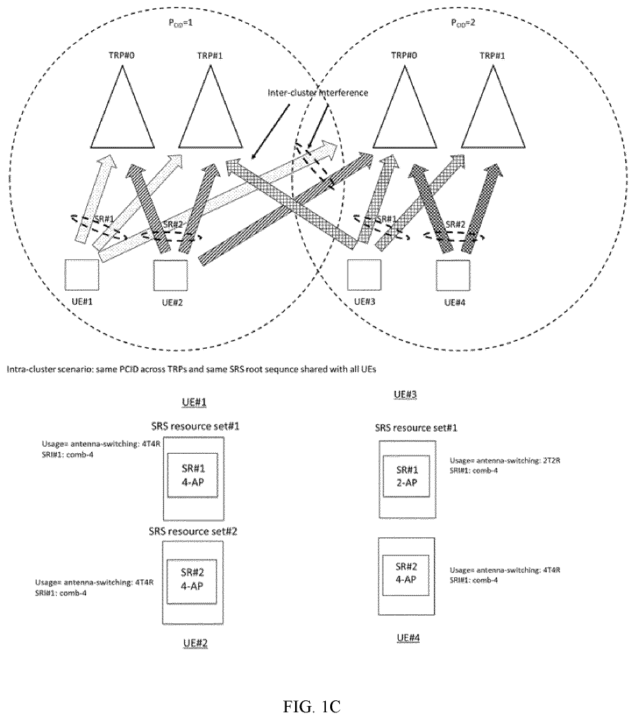

For illustrative purposes, principle and example embodiments of the present disclosure will be described below with reference to FIG. 1A to FIG. 6. However, it is to be noted that these embodiments are given to enable the skilled in the art to understand inventive concepts of the present disclosure and implement the solution as proposed herein, and not intended to limit scope of the present application in any way.

FIG. 1A illustrates an example of an application scenario 100 in which some example embodiments of the present disclosure may be implemented. The application scenario 100, which is a part of a communication network, includes terminal devices and network devices.

In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

The network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 can provide multiple serving cells and the terminal device 120 may switch from a source cell to a target cell between the serving cells during its mobility. It is to be understood that the number of serving cell(s) shown in FIG. 1A is for illustrative purposes without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes without suggesting any limitation. The communication system 100 may comprise any suitable number of devices adapted for implementing embodiments of the present disclosure.

As illustrated in FIG. 1A, the communication network 100 may include a network device 110 (which may also be referred to as a gNB or BS). The communication network 100 may further include a terminal device 120 (which may also be referred to as user equipment 120 or UE 120. Although only one network device 110 and one terminal devices 120 are shown in FIG. 1A, the numbers of the network device and the terminal device are not limited. In other words, there may be one or more network devices 110 and one or more terminal devices 120 in the network.

For Rel-18, intra-cluster and inter-cluster interference (cross-SRS) interference scenarios are considered for TDD based DL C-JT where persistent UL SRS interference occurs at frequency domain when the different user specific SRS sequences from multiple UEs with corresponding SRS resources overlap in resource element (RE) domain (i.e. sharing same symbol, PRBs, comb-type and comb offset). FIG. 1B illustrates an example of intra-cluster interference scenarios for time division duplex (TDD) based coherent joint transmission (C-JT), and FIG. 1C illustrates an example of inter-cluster interference scenarios for TDD based C-JT.

For inter-cluster interference scenario, multiple clusters can be deployed where each cluster can have a set of TRPs sharing a cluster specific physical cell-ID and UEs sharing the same cluster specific UL SRS Zadoff-Chu (ZC)-sequences group index (i.e. root sequence out of 30 different groups of sequences). In the case of intra-cluster interference scenario, it can be assumed that a set of TRPs shares same physical cell ID within same cluster and UEs with UL SRS ZC-sequences configured with same root sequences.

As discussed earlier, Rel-18 will specify support for the initialization of UL SRS comb-offset hopping and/or cyclic-shift hopping either by specifying option 1, where existing SRS sequence identity nID SRS or defining new scheme, i.e. option 2, where one or two new IDs are introduced.

Regarding to option 1 and option 2, ambiguity remains what kind of new IDs are needed and how Rel-18 UE configured/indicated initialization information for UL SRS comb-offset and/or cyclic-shift hopping. Furthermore, it remains unclear what is the corresponding UE behaviors (i.e. how the UE should interpret indicated information) for UL SRS with given configured/indicated information. Embodiments of the disclosure are provided in view of the above analysis and discussion.

Generally, embodiments of the disclosure propose new TCI state based UL SRS initialization method for UL SRS, and in some embodiments, to comb offset and cyclic shift hopping interference randomization. According to embodiments of the disclosure, the network device 110 may transmit a transmission configuration indicator (TCI) state to the terminal device 120. The terminal device 120 may receive the TCI state from the network device 110 and apply it as the indicated TCI state. The terminal device 120 may determine one or more initialization parameters based on the indicated TCI state. The terminal device 120 may further transmit a UL SRS to the network device 110 based on the at least one initialization parameter. In some embodiments, some transmission parameters such as comb offset and cyclic shift values may be derived and changed based on the initialization parameters to obtain interference randomization in the communication network 100.

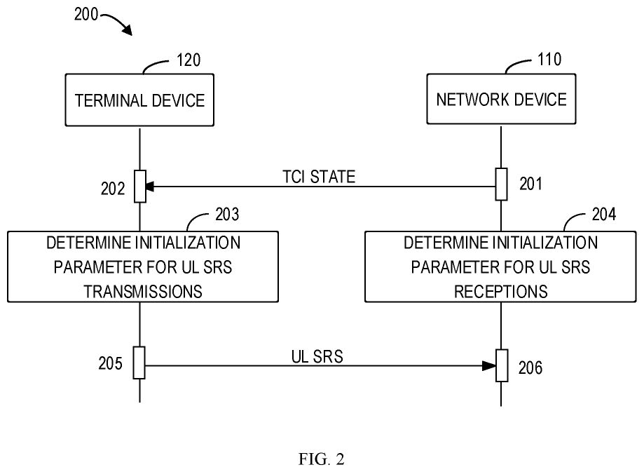

FIG. 2 illustrates an example of a process flow in accordance with some example embodiments of the present disclosure. For ease of understanding, the process flow 200 will be described with reference to FIG. 1A. It would be appreciated that although the process flow 200 has been described referring to the communication network 100 of FIG. 1A, this process flow 200 may be likewise applied to other similar communication scenarios.

The network device 110 transmits (201) a transmission configuration indicator (TCI) state to the terminal device 120. Accordingly, the terminal device 120 receives (202) the TCI state from the network device 110. In some embodiments, the network device 110 may indicate or transmit the TCI state via downlink control information (DCI). For example, the TCI state ID (among the up-to-8 activated TCI state IDs through MAC CE commands) applicable to a PUCCH/PUSCH transmission is indicated (e.g. by a number of bits) in DCI format 1_1 or 1_2 (DL assignment). In case there is no downlink assignment when the network device 110 wants to change the indicated TCI state ID to another value, then the DCI has all the fields (but the indicated TCI State ID) set to some default value. The indicated TCI state can be e.g. first indicated (unified) TCI or second indicated (unified) TCI state, where any TCI state ID 0 . . . N may be applied as indicated TCI state. The DCI has dedicated codepoint field that defines the first and/or second indicated TCI state. In some embodiments, the TCI state for UL SRS may be one of the first and/or second indicated TCI state.

Alternatively or additionally, the network device 110 may include the TCI state as configuration in a radio resource control (RRC) message. For example, the TCI state may be configured in an information element (IE) of an SRS resource or SRS resource set associated with UL SRS. In some embodiments, an identifier (ID) of the TCI state is associated with an SRS resource ID or an SRS resource set ID associated with the UL SR. For example, the TCI state ID may be configured in the IE srs-TCIState-r17 via the RRC message. Further, there is a flag called follow UnifiedTCIstate SRS that controls whether SRS is to follow the TCI state ID indicated via DCI instead of the one configured via RRC.

Upon receiving (202) the TCI state, the terminal device 120 determines (203) at least one initialization parameter for UL sounding reference signal (SRS) transmissions based on the TCI state. The TCI state as indicated may indicate the initialization parameter(s) for UL SRS with comb offset hopping and/or cyclic shift hopping. The initialization parameter(s) may be associated with the TCI state and used to calculate the comb offset and/or cyclic shift hopping of UL SRS to obtain corresponding interference randomization.

In some embodiments, when the terminal device 120 is configured with an IE of DLorJoint-TCIState or UL-TCIState and UL SRS resource set is configured with follow UnifiedTCIstate-r17 (i.e. the comb offset and/or cyclic shift hopping parameter follows or is associated with indicated (unified) TCI state), the terminal device 120 may apply the comb offset hopping and cyclic shift hopping initialization parameters for the TCI State ID that is applied as indicated TCI state. In some embodiments, the terminal device 120 may assume that comb-offset hopping and cyclic-shift hopping initialization parameters are provided via TCI state specific IE srsCombAndCyclicHopping.

In some embodiments, the initialization parameter(s) may include at least one of the following elements: an SRS sequence identity, a Cell-Radio Network Temporary Identifier (C-RNTI) associated with uplink/downlink (UL/DL) DCI triggering the UL SRS transmissions or with DL DCI indicating the TCI state, a slot index of the UL SRS; a symbol index of the UL SRS; a configured comb offset; a configured cyclic shift; a physical cell ID; a UL SRS resource ID; a UL SRS resource set ID; or a TCI state ID.

The terminal device 120 is provided an indication for initialization parameters for UL SRS transmission with comb-offset hopping and/or cyclic-shift hopping associated with the indicated TCI-State. In some embodiments, the indicated TCI-state may share initialization parameters with a certain TCI-state. To this end, the association between the indicated and the certain TCI-state may be implicitly/explicitly indicated or configured.

In some embodiments, association between one or more sets of indicated TCI states and one or more certain TCI state(s) (a.k.a. reference TCI states) may be defined. That is, TCI states may be grouped, and the TCI states in the same group have common initialization parameter(s) of the associated reference TCI state. In some embodiments, based on the received TCI state (a first TCI state) and the association, the terminal device 120 may determine one of the reference TCI states (a second TCI state) which is associated with the received TCI state, and determine the initialization parameter(s) based on the reference TCI state.

In some embodiments, the association between the indicated and the reference TCI state may be explicitly indicated or configured. In explicit indication or configuration, the set of indicated TCI-states are associated with initialization parameter(s) based on which the terminal device 120 determines initialization parameters for computing UL SRS comb offset and/or cyclic shift hopping values. In some embodiments, the network device 110 may configure the terminal device 120 with the association between one or more sets of TCI states and the reference TCI states via a radio resource control (RRC) message. One set of TCI state IDs can be associated or mapped to only one TCI state ID. For example, indicated TCI state IDs 0-6 may be associated with TCI state ID 0.

In implicit indication, the terminal device 120 may determine a reference or certain TCI state based on a TCI state association rule without any additional signaling that indicated one or more sets of TCI state IDs are associated with one or more certain TCI state IDs. The TCI association rule may be defined such that, for example, indicated TCI state IDs <11 are associated with a TCI state with ID 0 (or with configured TCI state with lowest state ID) and indicated TCI state IDs >10 are associated with a TCI-state with ID 11.

After transmitting (201) the TCI state to the terminal device 120, the network device 110 determines (204) at least one initialization parameter for UL SRS receptions based on the TCI state. The network device 110 may determine the initialization parameter(s) in a similar way as the terminal device 120. Details are omitted for brevity.

After determining (203) the at least one initialization parameter, the terminal device 120 transmits (205) a UL SRS to the network device 110 based on the at least one initialization parameter. Accordingly, the network device 110 receives (206) the UL SRS from the terminal device 120. In some embodiments, the terminal device 120 may determine a comb offset and/or a cyclic shift for the UL SRS based on the initialization parameter(s). The terminal device 120 may further transmit the UL SRS based on the comb offset and/or the cyclic shift.

In some embodiments, the comb offset hopping and/or cyclic-shift hopping parameter may be associated with the indicated TCI state (i.e. parameter is not specifically configured per TCI state). The indicated TCI state may be e.g. first indicated (unified) TCI or second indicated (unified) TCI state (e.g. in DCI), where any TCI state ID 0 . . . N may be applied as indicated TCI state. When a TCI State is applied as indicated TCI state, the comb offset hopping and/or cyclic shift hopping may be associated with any of the TCI state ID that is the indicated one: any TCI state applied as indicated TCI state may apply the comb offset hopping and/or cyclic shift hopping parameter associated with the (first or second or Nth) indicated TCI state. In some embodiments, the indicated TCI state used for the initialization of comb offset and/or cyclic shift hopping may be CORESETpoolindex specific.

In some embodiments, the terminal device 120 may be configured with explicit association between one or more sets of indicated TCI states and one or more certain TCI states for UL SRS comb offset hopping and/or cyclic shift hopping. After the terminal device 120 receives DCI comprising TCI codepoint field with an indicated TCI state, the terminal device 120 may apply configured association between a certain TCI-state and indicated TCI-state and apply the initialization parameters associated with the certain TCI state to the indicated TCI state and corresponding UL SRS resource set with resources configured with UL SRS comb offset hopping and cyclic shift hopping. Based on the indicated TCI state (possibly associated with a certain TCI state), on the slot index (=X1) and symbol index (=X2), the terminal device 120 may determine, for UL SRS antenna port pᵢ, the initialization of frequency domain starting position of UL SRS resource for comb offset hopping as follows:

$${\overline{k}}_{0}^{( {p}_{i} )} = {n}_{shift} {N}_{s c}^{R B} + ( {k}_{T C}^{( {p}_{i} )} + g ( X 1 , X 2 , X 3 , … ) ) mod {K}_{T C}$$

where K_{TC} is transmission comb number, K_{TC}={2,4,8} and

$${N}_{sc}^{RB}$$

is the number of resource elements in physical resource block (e.g. 12 resource elements), and n_{shift} is physical resource block offset (PRB) in PRBs, and g( ) defines a hopping function having specific initialization parameters X1, X2, X3, . . . , as input parameters. For example, X1=slot offset, X2=OFDM symbol index, and X₃ is some initialization parameter dependent on the TCI state, for instance the ID of the indicated TCI State or of the certain TCI state associated with the indicated TCI state. In addition, the function g( ) can also be a function of one or more further TCI state specific initialization parameters, i.e. initialization parameters that depend on the TCI state. In some embodiments, the mapping from the TCI states to the corresponding function and input parameters may be configured by an indication (e.g. RRC message) or defined in a requirement. The parameter

$${k}_{T C}^{( {p}_{i} )}$$

is comb-offset shift value, which may be common for all antenna ports associated with the UL SRS resource or resource set. Thus, comb offset value may be randomized by use of the function g, which depends on the indicated TCI state.

Based on the explicit association between a set of certain TCI states and indicated TCI-state (associated with TCI state for example with slot index (=X1), could be also any initialization parameter), the terminal device 120 may determine a cyclic shift αᵢ for UL SRS antenna port pᵢ as follows

$${α}_{i} = 2 π \frac{{n}_{SRS}^{cs , i}}{{n}_{SRS}^{cs , max}}$$

$${n}_{SRS}^{cs , i} = \{ \begin{matrix}\begin{matrix}( {n}_{SRS}^{cs} + q ( X 1 , X 2 , … ) + \frac{{n}_{SRS}^{cs , max} ⌊ ( {p}_{i} - 1000 ) / 2 ⌋}{{n}_{ap}^{SRS} / 2} ) mod {n}_{SRS}^{cs , max} , \\ if {n}_{ap}^{SRS} = 4 and {n}_{SRS}^{cs , max} = 6\end{matrix} \\ ( {n}_{SRS}^{cs} + q ( X 1 , X 2 , … ) + \frac{( {n}_{SRS}^{cs , max} ( {p}_{i} - 1000 )}{{n}_{ap}^{SRS}} ) , otherwise\end{matrix}$$

where

$${n}_{S R S}^{c s} \{ 0 , 1 , … {n}_{S R S}^{cs , max} \}$$

is cyclic-shift offset configured by higher layers, where

$${n}_{S R S}^{cs , max}$$

is the maximum number of cyclic-shifts given by table, q( ) defines a hopping function having specific initialization parameter X1, X2, . . . , as input parameters. For example X1=slot index (provided a part of TCI), and X2 is some initialization parameter dependent on the TCI state, for instance the ID of the indicated TCI state or of the certain TCI state associated with the indicated TCI state. The function q( ) can also be a function of one or more further TCI state specific initialization parameters. The above Table 1 shows maximum number of cyclic shifts

$${n}_{SRS}^{cs , max}$$

as a function of comb-number K_{TC}.

In some embodiments, implicit indication based on a specific TCI state association rule is used. The terminal device 120 may determine based on the TCI state association rule without any additional signaling that indicated one or more sets of TCI state IDs are associated with one or more TCI state IDs. The TCI association rule may be defined such that for example, indicated TCI state IDs <11, always associated with TCI-state with ID 0 (or with configured TCI state with lowest state ID) and indicated TCI state IDs >10 always associated with TCI-state with ID 11. The terminal device 120 may obtain the initialization parameter(s) associated with the TCI state which is mapped to, and calculate the comb offset hopping and cyclic shift hopping based the initialization parameter(s), for example, using the above example formulas.

By doing this, the comb offset and the cyclic shift values may be changed between successive UL SRS transmissions and receptions based on the formula having the initialization parameter(s) as input parameter. Therefore, the UL SRS transmitted from the terminal device 120 to the network device 110 may have improved interference randomization.

In view of the above, embodiments of the disclosure use additional dimension, i.e. TCI state, to enhance UL SRS interference randomization. In some embodiments, single cluster or multiple clusters can be sub-divided into TCI states (associated with different TRPs or Coreset Pool Indexes) which can be configured with TCI state specific initialization parameters. As a result of interference randomization, CSI quality for UL and DL transmission can be significantly improved in comparison with existing methods.

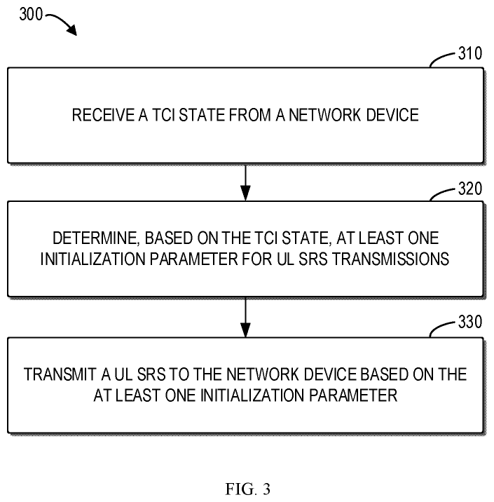

FIG. 3 illustrates a flowchart of an example method 300 implemented at a terminal device in accordance with some other embodiments of the present disclosure. For ease of understanding, the method 300 will be described from the perspective of the terminal device 120 with reference to FIG. 1A.

At block 310, the terminal device 120 receives a TCI state from a network device 110. In some embodiments, the TCI state may be indicated via downlink control information (DCI) from the network device 110. The DCI may comprise at least two TCI states, and the TCI state may be one of the at least two TCI states. Alternatively or additionally, the TCI state may be configured in an information element of an SRS resource or an SRS resource set associated with the UL SRS via a RRC message. In some embodiments, an ID of the TCI state may be associated with an SRS resource ID or an SRS resource set ID associated with the UL SRS. In some embodiments, the TCI state may be specific to a CORESET pool index.

At block 320, the terminal device 120 determines, based on the TCI state, at least one initialization parameter for UL SRS transmissions. The at least one initialization parameter may be associated with the TCI state. In some embodiments, the at least one initialization parameters may include at least one of: an SRS sequence identity, a Cell-Radio Network Temporary Identifier (C-RNTI) associated with uplink/downlink (UL/DL) DCI triggering the UL SRS transmissions or with DL DCI indicating the TCI state, a slot index of the UL SRS; a symbol index of the UL SRS; a configured comb offset; a configured cyclic shift; a physical cell ID; a UL SRS resource ID; a UL SRS resource set ID; or a TCI state ID.

In some embodiments, the TCI state is a first TCI state, and the terminal device 120 may determine a second TCI state associated with the first TCI state, and determine the at least one initialization parameter based on the second TCI state. The at least one initialization parameter may be associated with the second TCI state. In some embodiments, the at least one initialization parameter may be common to a set of TCI states comprising the first TCI state and the second TCI state.

In some embodiments, an association between the first TCI state and the second TCI state is configured via a RRC message. Alternatively or additionally, the association between the first TCI state and the second TCI state may be predefined based on a rule at the terminal device.

At 330, the terminal device 120 transmits a UL SRS to the network device 110 based on the at least one initialization parameter. In some embodiments, the terminal device 120 may determine a comb offset and/or a cyclic shift for the UL SRS based on the at least one initialization parameter, and transmit the UL SRS based on the comb offset and/or the cyclic shift. In some embodiments, the comb offset and/or the cyclic shift is changed between successive UL SRS transmissions based on a formula having the at least one initialization parameter as input parameter.

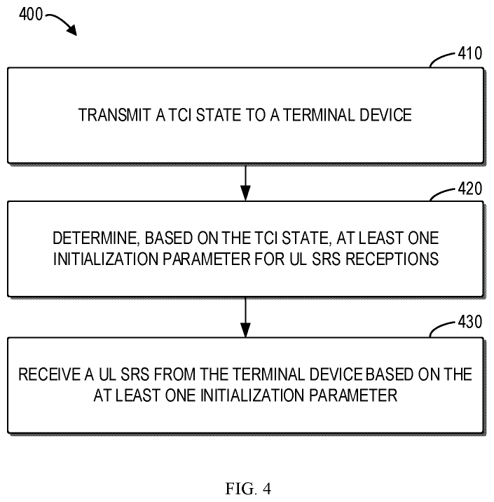

FIG. 4 illustrates another flowchart of an example method implemented at a network device in accordance with some embodiments of the present disclosure. For ease of understanding, the method 400 will be described from the perspective of the terminal device 120 with reference to FIG. 1A.

At block 410, the network device 110 transmits a TCI state to a terminal device 120. In some embodiments, the TCI state may be indicated via downlink control information (DCI). The DCI may comprise at least two TCI states, and the TCI state may be one of the at least two TCI states. Alternatively or additionally, the TCI state may be configured in an information element of an SRS resource or an SRS resource set associated with the UL SRS via a RRC message. In some embodiments, an ID of the TCI state may be associated with an SRS resource ID or an SRS resource set ID associated with the UL SRS. In some embodiments, the TCI state may be specific to a CORESET pool index.

At block 420, the network device 110 determines, based on the TCI state, at least one initialization parameter for UL SRS receptions. The at least one initialization parameter may be associated with the TCI state. In some embodiments, the at least one initialization parameters may include at least one of: an SRS sequence identity, a Cell-Radio Network Temporary Identifier (C-RNTI) associated with uplink/downlink (UL/DL) DCI triggering the UL SRS transmissions or with DL DCI indicating the TCI state, a slot index of the UL SRS; a symbol index of the UL SRS; a configured comb offset; a configured cyclic shift; a physical cell ID; a UL SRS resource ID; a UL SRS resource set ID; or a TCI state ID.

In some embodiments, the TCI state is a first TCI state, and the network device 110 may determine a second TCI state associated with the first TCI state, and determine the at least one initialization parameter based on the second TCI state. The at least one initialization parameter may be associated with the second TCI state. In some embodiments, the at least one initialization parameter may be common to a set of TCI states comprising the first TCI state and the second TCI state.

In some embodiments, the network device 110 may configure the terminal device 120 with an association between the first TCI state and the second TCI state via a radio resource control (RRC) message. Alternatively or additionally, the association between the first TCI state and the second TCI state may be predefined based on a rule at the network device.

At 430, the network device 110 receives a UL SRS from the terminal device 120 based on the at least one initialization parameter. In some embodiments, the network device 110 may determine a comb offset and/or a cyclic shift for the UL SRS based on the at least one initialization parameter, and receive the UL SRS based on the comb offset and/or the cyclic shift. In some embodiments, the comb offset and/or the cyclic shift is changed between successive UL SRS receptions based on a formula having the at least one initialization parameter as input parameter.

In some embodiments, an apparatus capable of performing the method 300 (for example, the terminal device 120) may comprise means for performing the respective steps of the method 300. The means may be implemented in any suitable form. For example, the means may be implemented in a circuitry or software module.

In some example embodiments, the apparatus comprises: means for receiving a transmission configuration indicator (TCI) state from a network device; means for determining, based on the TCI state, at least one initialization parameter for uplink (UL) sounding reference signal (SRS) transmissions; and means for transmitting a UL SRS to the network device based on the at least one initialization parameter.

In some embodiments, means for transmitting the UL SRS to the network device based on the at least one initialization parameter may comprise means for determining at least one of a comb offset and a cyclic shift for the UL SRS based on the at least one initialization parameter; and means for transmitting the UL SRS based on the at least one of the comb offset and the cyclic shift.

In some embodiments, the at least one of the comb offset and the cyclic shift may be changed between successive UL SRS transmissions based on a formula having the at least one initialization parameter as input parameter.

In some embodiments, the TCI state may be a first TCI state, and the apparatus may further comprise means for determining a second TCI state associated with the first TCI state and means for determining the at least one initialization parameter based on the second TCI state.

In some embodiments, the at least one initialization parameter may be common to a set of TCI states comprising the first TCI state and the second TCI state.

In some embodiments, an association between the first TCI state and the second TCI state may be configured via a radio resource control (RRC) message.

In some embodiments, an association between the first TCI state and the second TCI state may be predefined based on a rule at the apparatus.

In some embodiments, the TCI state may be indicated via downlink control information (DCI), or may be configured in an information element of an SRS resource or an SRS resource set associated with the UL SRS via a second RRC message.

In some embodiments, the DCI may comprise at least two TCI states, and the TCI state may be one of the at least two TCI states.

In some embodiments, an identifier (ID) of the TCI state may be associated with an SRS resource ID or an SRS resource set ID associated with the UL SRS.

In some embodiments, the at least one initialization parameter may be associated with the TCI state.

In some embodiments, the TCI state may be specific to a CORESET pool index.

In some embodiments, the at least one initialization parameter may comprise at least one of the following: an SRS sequence identity; a C-RNTI associated with uplink/downlink (UL/DL) DCI triggering the UL SRS transmissions or with DL DCI indicating the TCI state;

a slot index of the UL SRS; a symbol index of the UL SRS; a configured comb offset; a configured cyclic shift; a physical cell ID; a UL SRS resource ID; a UL SRS resource set ID; or a TCI state ID.

In some embodiments, the apparatus further comprises means for performing other steps in some embodiments of the method 300. In some embodiments, the means comprises at least one processor and at least one memory including computer program code, the at least one memory and computer program code configured to, with the at least one processor, cause the performance of the apparatus.

In some embodiments, an apparatus capable of performing the method 400 (for example, the network device 110) may comprise means for performing the respective steps of the method 400. The means may be implemented in any suitable form. For example, the means may be implemented in a circuitry or software module.

In some example embodiments, the apparatus comprises: means for transmitting a transmission configuration indicator (TCI) state to a terminal device; means for determining, based on the TCI state, at least one initialization parameter for uplink (UL) sounding reference signal (SRS) receptions; and means for receiving a UL SRS from the terminal device based on the at least one initialization parameter.

In some embodiments, means for receiving the UL SRS from the terminal device based on the at least one initialization parameter may comprise means for determining at least one of a comb offset and a cyclic shift for the UL SRS based on the at least one initialization parameter; and means for receiving the UL SRS based on the at least one of the comb offset and the cyclic shift.

In some embodiments, the at least one of the comb offset and the cyclic shift may be changed between successive UL SRS receptions based on a formula having the at least one initialization parameter as input parameter.

In some embodiments, the TCI state may be a first TCI state, and the apparatus may further comprise means for determining a second TCI state associated with the first TCI state and means for determining the at least one initialization parameter based on the second TCI state.

In some embodiments, the at least one initialization parameter may be common to a set of TCI states comprising the first TCI state and the second TCI state.

In some embodiments, the apparatus may comprise means for configuring the terminal device with an association between the first TCI state and the second TCI state via a radio resource control (RRC) message.

In some embodiments, an association between the first TCI state and the second TCI state may be predefined based on a rule at the apparatus.

In some embodiments, the TCI state may be indicated via downlink control information (DCI), or may be configured in an information element of an SRS resource or an SRS resource set associated with the UL SRS via a second RRC message.

In some embodiments, the DCI may comprise at least two TCI states, and the TCI state may be one of the at least two TCI states.

In some embodiments, an identifier (ID) of the TCI state may be associated with an SRS resource ID or an SRS resource set ID associated with the UL SRS.

In some embodiments, the at least one initialization parameter may be associated with the TCI state.

In some embodiments, the TCI state may be specific to a CORESET pool index.

In some embodiments, the at least one initialization parameter may comprise at least one of the following: an SRS sequence identity; a C-RNTI associated with uplink/downlink (UL/DL) DCI triggering the UL SRS transmissions or with DL DCI indicating the TCI state; a slot index of the UL SRS; a symbol index of the UL SRS; a configured comb offset; a configured cyclic shift; a physical cell ID; a UL SRS resource ID; a UL SRS resource set ID; or a TCI state ID.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

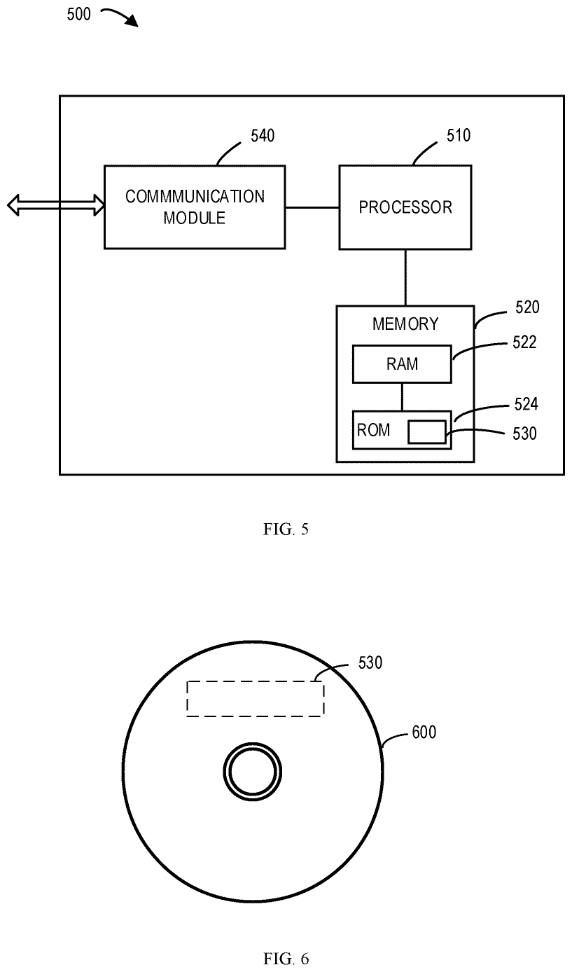

FIG. 5 illustrates a simplified block diagram of a device 500 that is suitable for implementing some example embodiments of the present disclosure. The device 500 may be provided to implement a communication device, for example, the network device 110 or the terminal device 120 as shown in FIG. 1A. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIGS. 3 and 4. The embodiments of the present disclosure may also be implemented by hardware or by a combination of software and hardware.

In some example embodiments, the program 530 may be tangibly contained in a computer-readable medium which may be included in the device 500 (such as in the memory 520) or other storage devices that are accessible by the device 500. The device 500 may load the program 530 from the computer-readable medium to the RAM 522 for execution. The computer-readable medium may include any types of tangible non-volatile storage, such as ROM, EPROM, a flash memory, a hard disk, CD, DVD, and the like.

FIG. 6 illustrates a block diagram of an example of a computer-readable medium 600 in accordance with some example embodiments of the present disclosure. The computer-readable medium 600 has the program 530 stored thereon. It is noted that although the computer-readable medium 600 is depicted in form of CD or DVD in FIG. 5, the computer-readable medium 600 may be in any other form suitable for carry or hold the program 530.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 300 or 400 as described above with reference to FIG. 3 or 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive a transmission configuration indicator (TCI) state from a network device;
determine, based on the TCI state, at least one initialization parameter for uplink (UL) sounding reference signal (SRS) transmissions; and
transmit a UL SRS to the network device based on the at least one initialization parameter.

2. The terminal device of claim 1, wherein the terminal device is caused to transmit the UL SRS to the network device based on the at least one initialization parameter by:
determining at least one of a comb offset and a cyclic shift for the UL SRS based on the at least one initialization parameter; and
transmitting the UL SRS based on the at least one of the comb offset and the cyclic shift.

3. The terminal device of claim 2, wherein the at least one of the comb offset and the cyclic shift is changed between successive UL SRS transmissions based on a formula having the at least one initialization parameter as input parameter.

4. The terminal device of claim 1, wherein the TCI state is a first TCI state, and the terminal device is further caused to:
determine a second TCI state associated with the first TCI state;
determine the at least one initialization parameter based on the second TCI state.

5. The terminal device of claim 4, wherein the at least one initialization parameter is common to a set of TCI states comprising the first TCI state and the second TCI state.

6. The terminal device of claim 4, wherein an association between the first TCI state and the second TCI state is configured via a radio resource control (RRC) message.

7. The terminal device of claim 4, wherein an association between the first TCI state and the second TCI state is predefined based on a rule at the terminal device.

8. The terminal device of claim 1, wherein the TCI state is indicated via downlink control information (DCI), or is configured in an information element of an SRS resource or an SRS resource set associated with the UL SRS via a second RRC message.

9. The terminal device of claim 8, wherein the DCI comprises at least two TCI states, and the TCI state is one of the at least two TCI states.

10. The terminal device of claim 1, wherein an identifier (ID) of the TCI state is associated with an SRS resource ID or an SRS resource set ID associated with the UL SRS.

11. The terminal device of claim 1, wherein the at least one initialization parameter is associated with the TCI state.

12. The terminal device of claim 1, wherein the TCI state is specific to a CORESET pool index.

13. The terminal device of claim 1, wherein the at least one initialization parameter comprises at least one of the following:
an SRS sequence identity;
a C-RNTI associated with uplink/downlink (UL/DL) DCI triggering the UL SRS transmissions or with DL DCI indicating the TCI state;
a slot index of the UL SRS;
a symbol index of the UL SRS;
a configured comb offset;
a configured cyclic shift;
a physical cell ID;
a UL SRS resource ID;
a UL SRS resource set ID; or
a TCI state ID.

14. A network device comprising:
at least one processor; and
at least one memory storing instructions that, when executed by the at least one processor, cause the network device at least to:
transmit a transmission configuration indicator (TCI) state to a terminal device;
determine, based on the TCI state, at least one initialization parameter for uplink (UL) sounding reference signal (SRS) receptions; and
receive a UL SRS from the terminal device based on the at least one initialization parameter.

15. The network device of claim 14, wherein the network device is caused to receive the UL SRS from the terminal device based on the at least one initialization parameter by:
determining at least one of a comb offset and a cyclic shift for the UL SRS based on the at least one initialization parameter; and
receiving the UL SRS based on the at least one of the comb offset and the cyclic shift.

16. The network device of claim 15, wherein the at least one of the comb offset and the cyclic shift is changed between successive UL SRS receptions based on a formula having the at least one initialization parameter as input parameter.

17. The network device of claim 14, wherein the TCI state is a first TCI state, and the network device is further caused to:
determine a second TCI state associated with the first TCI state;
determine the at least one initialization parameter based on the second TCI state.

18. The network device of claim 17, wherein the at least one initialization parameter is common to a set of TCI states comprising the first TCI state and the second TCI state.

19. The network device of claim 17, the network device is further caused to configure the terminal device with an association between the first TCI state and the second TCI state via a radio resource control (RRC) message.

20-26. (canceled)

27. A method comprising:
receiving a transmission configuration indicator (TCI) state from a network device;
determining, based on the TCI state, at least one initialization parameter for uplink (UL) sounding reference signal (SRS) transmissions; and
transmitting a UL SRS to the network device based on the at least one initialization parameter.

28-32. (canceled)
